(19) United States
(12) Patent Application Publication
(10) Pub. No.: US 2009/0199526 A1
(43) Pub. Date: Aug. 13, 2009

(54) Easy Access Air Filter Housing

(76) Inventor: Stephen A. Wallace, Montgomery, TX (US)

Correspondence Address: BURLESON COOKE L.L.P., 2040 NORTH LOOP 336 WEST, SUITE 123, CONROE, TX, 77304, US

(21) Appl. No.: 12/427,511

(22) Filed: Apr. 21, 2009

(51) Int. Cl. B01D 35/30; B01D 46/10; B23P 6/00; B25B 27/00

(52) U.S. Cl. 55/493; 29/402.08; 29/270

(57) ABSTRACT

An easy access air filter housing and cover assembly for homes with tall ceilings is provided that enables a user to replace the air filter without the need of standing on a ladder. A kit including special tools and a conventional extendable pole is provided to enable the user to change the filter according to a novel method of changing the filter.

### BACKGROUND OF INVENTION

1. Field of the Invention

This invention relates to an easy access air filter housing that facilitates the replacement of air filters by individuals, especially in instances where the air filter is located in a housing that is mounted in a ceiling.

2. Description of Related Art

In prior art filter housings, as shown in FIGS. 1 and 2 of the drawings, the process of replacing air filters on a regular basis using known housings is awkward and can lead to serious injury especially when the filter housing is located in the ceiling of a home. Newer homes are often constructed with ceiling heights of 8 feet and higher. Large return air ducts are being located in the ceiling with air filters located in the housing at the intake area of the air duct. To replace the filter it is necessary in many cases to stand on a ladder in an awkward position, unlatch a cover on the housing, carefully avoid the cover from falling on the individual, remove and replace the filter, close the cover and then manipulate a latching mechanism to secure the filter in the housing. The hinge mounting the cover to the housing is typically of the type that does not include a mechanical interconnection between the two segments of the hinge and thus the cover can easily become detached from the housing. Such a hinge is shown at 51 in FIG. 2. A typical latching mechanism is shown in FIG. 1 and includes a slot 53 and latching member 52.

### BRIEF SUMMARY OF THE INVENTION

The problems of the prior art are overcome by the present invention. The cover is provided with a latching mechanism that can be manipulated by the individual without the need of a ladder. The cover is provided with an improved hinge in the form of one or more conventional piano type hinges that are secured to the cover and housing and having a pivot mechanism that mechanically interconnects the two portions of the hinge so that they cannot become unattached to each other in normal use. The periphery of the cover or an internal portion of the housing is equipped with a plurality of magnets that secure the cover to the housing. A first tool has a hook-like portion adapted to engage the cover and grasp it through one of the slot-like openings typically formed through the surface of the cover to move the cover to an open position. A second tool is provided that attaches to known extendable poles and includes platforms to support the filter. The filter to be replaced can be gripped by either tool, depending on the type of filter, and removed. A clean filter can then be placed on the second tool and inserted into the housing. With the furnace fan on at this point the air flow will hold the filter in place and the cover can be rotated up to engage the housing and be held in a closed position by virtue of the magnets. All this can be done without the need of a ladder.

### BRIEF DESCRIPTION OF THE SEVERAL VIEWS OF THE DRAWING(S)

FIGS. 1 and 2 are representative of the prior art.

FIG. 3 is a perspective view of the housing and cover of the present invention.

FIG. 4 is a perspective view of the housing, cover and hinge.

FIG. 5 depicts a user supporting the filter on the end of the second tool.

FIG. 6 is a perspective view of the second tool attached to the extendable pole

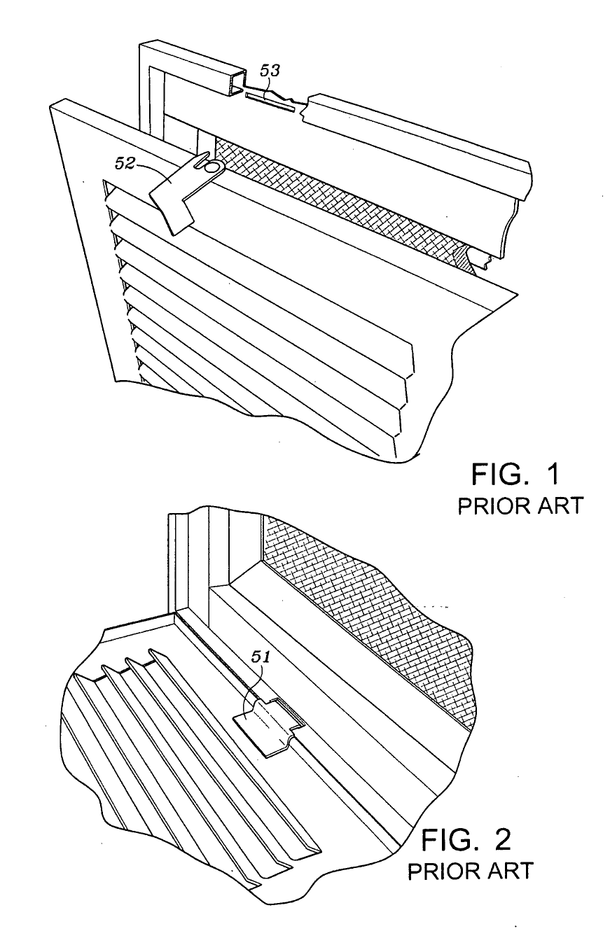

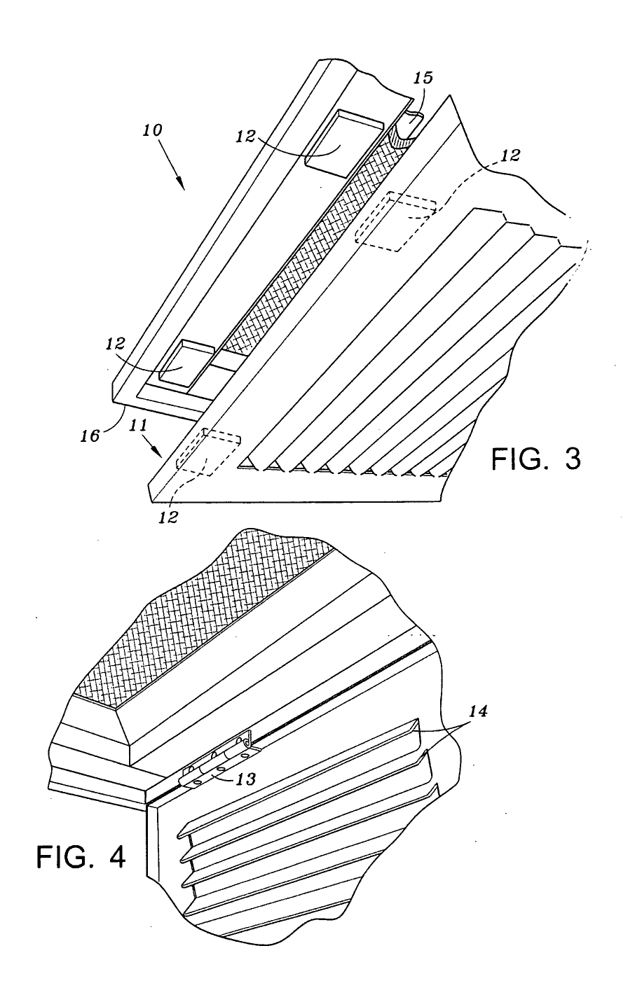

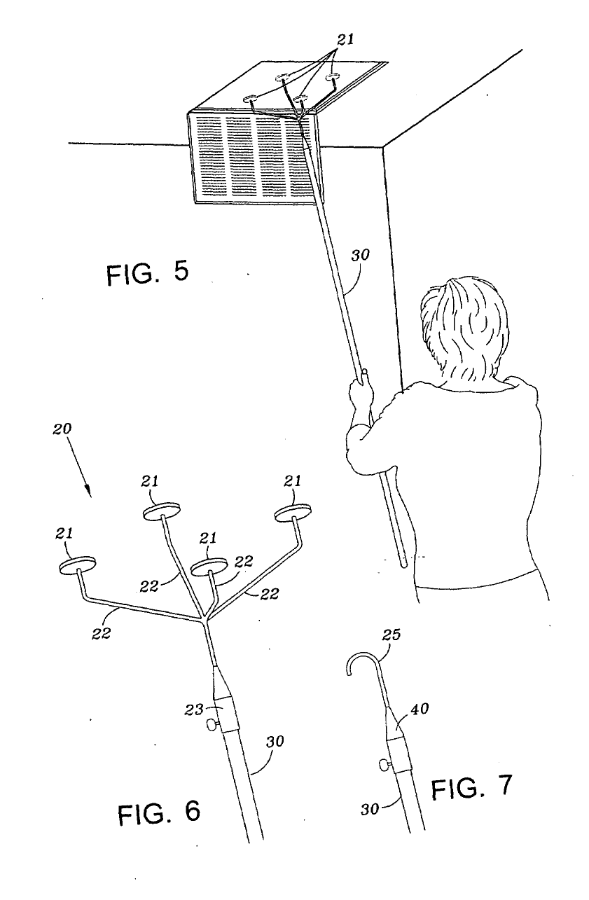

FIG, 7 is a perspective view of the first tool attached to the extendable pole.

### DETAILED DESCRIPTION OF THE INVENTION

As shown in FIG. 3, there is provided a housing member 10 which consists of four side members. The housing is typically rectangular or square in shape and is adapted to be mounted in a ceiling in a known manner. Each side of the housing includes a main frame member 16. The housing includes an inwardly extending flange 15 that cooperates with a cover 11 to form a filter compartment. Along one side of the housing, one or more piano-type hinges 13 rotatably secure the cover to the housing. In lieu of two separately mounted hinges, it is within the scope of the invention to use a single piano type hinge that extends for a substantial portion of the side of the housing and cover to which it is attached. A plurality of magnets 12 are secured to the outer periphery of the cover or internally within the housing. The number and position of the magnets is not critical; however it is desirable to have at least two magnets mounted on the side of the cover or housing that is opposite the side that has the hinge(s) mounted on them. The housing may be rectangular or square in shape. In the event that the housing is rectangular in shape, the cover could be pivotably mounted either on the longer or shorter side of the housing.

As shown in FIG. 3, the cover has the same general shape as the opening in the housing and is provided with a plurality of air slots 14 to permit the flow of air through the filter and housing. The sides of the cover are slightly less in length than the corresponding lengths of the housing to allow the cover to rotate into and out of the housing. The hook portion of the first tool is adapted to fit within one of the slots 14 in the cover to allow the user to pivot the cover to an open position.

A support tool adapted to be used in conjunction with the housing is shown in FIG. 6. The tool includes a body portion 23 and a plurality of support members 22 extending radially outwardly from the body portion. A support platform which may be a disk-shaped magnet is attached to the end of each support member. The tool has at the lower end of the body portion a socket for attachment to a conventional extendable pole. The lower end of the body is also provided with a suitable locking mechanism such as a set screw to lock the extension pole within the socket. The radially outwardly extending support members may be adjustable in length by any suitable known means, such as telescoping rod-like members. Detent members or set screws may be provided in a known manner to hold the rods in place at a selected length.

The hook-like tool is shown in FIG. 7. It includes a main body portion 40 with a socket at one end adapted to receive a known extendable pole. The socket is provided with a locking mechanism such as a set screw to secure the pole within the socket. A hook-like member 25 extends from the other end of the body.

In operation, the user places the hook-like tool on the end of the pole and engages the cover through one of the slots. The cover is then pulled downwardly to an open position. A typical filter may have a metal mesh screen on one side thereof which can be engaged by the support tool and its magnets to remove the filter from the housing. If there is not a metal mesh screen on the face of the filter, the hook-like tool can be used to penetrate the filter and remove it. All of this may be done while the air system fan is running. A VELCRO surface may be applied to the filter and to the opening for the filter. After the old filter is removed, a new filter is placed on the support tool and moved into the housing. The air flow will keep the filter within the housing. The tools or extension pole can then be used to rotate the cover back into engagement with the housing.

As can be appreciated, the present invention provides a simple yet elegant solution of the problems inherent in the prior art, including the very real possibility of serious bodily injury to anyone who is replacing an air filter under these conditions.

Although the present invention has been described with respect to specific details, it is not intended that such details should be regarded as limitations on the scope of the invention, except to the extent that they are included in the accompanying claims.

I claim:

1. A housing and cover assembly for removably supporting an air filter comprising a rectangular or square housing having four sides, a rectangular cover having a plurality of openings for allowing the flow of air thru the cover and of the same general shape of the housing, a hinge mechanism rotatably securing the cover to the housing so that the cover can be rotated into the housing thereby forming a chamber for supporting an air filter, the hinge mechanism including two pieces having one end secured to the housing and the other end secured to the cover, the two pieces being rotatably and mechanically interconnected at their other ends to each other so that in normal use the cover can not become detached from the housing, a plurality of magnets secured to either the periphery of the cover or the housing so that when the cover is rotated to a closed position within the housing, the cover is held in place by the magnets.

2. An easy access air filter housing and cover assembly comprising:
a quadrilateral frame member having opposing sides,
a complimentary shaped cover rotatably hinged to the frame member along one side thereof and forming a chamber adapted to receive an air filter, and
a plurality of magnets secured either to the housing or the cover to secure the cover to the housing in a closed position.

3. A housing and cover assembly as claimed in claim 1 wherein the hinge mechanism is a piano type hinge that extends along periphery of the cover and housing.

4. A housing and cover assembly as claimed in claim 1 wherein the hinge mechanism consists of two hinges located along the periphery of the cover and housing.

5. A tool for replacing air filters in a housing comprising:
a main portion having a socket for receiving an extension type pole at one end,
a plurality of outwardly extending support members secured to the main portion at its other end, and a support platform secured to the end of each support member.

6. A tool as claimed in claim 5 wherein the outwardly extending support members are adjustable in length.

7. A tool as claimed in claim 6 including detents spaced along the extending support members to secure the member at a given length.

8. A tool as claimed in claim 5 wherein the support platforms are disk-shaped magnets.

9. A kit for replacing filters in a ceiling mounted housing comprising
an extendable pole, a tool as claimed in claim 5, and a second tool comprising a body portion having a socket adapted to receive one end of the extendable pole and a hook-like member at the other end.

10. A method of replacing an air filter in a housing mounted in the ceiling of a structure, the housing having a cover rotatably secured to the housing and having a plurality of magnets either on the cover or the housing for holding the cover to the housing in a closed potion, comprising
grasping the cover with a tool secured to a pole and rotating the cover to an open position,
supporting the filter on a supporting tool at the end of the pole and removing the filter from the housing, placing a clean filter on the supporting tool, inserting the clean filter into the housing, and rotating the cover to the closed position using the pole or one of the tools attached to the pole.
